(19) United States
(12) Patent Application Publication
(10) Pub. No.: US 2006/0141264 A1
(43) Pub. Date: Jun. 29, 2006

(54) Soft feel coating for a rigid substrate

(76) Inventor: Brian K. Rearick, Allison Park, PA (US)

Correspondence Address: PPG Industries, Inc.;Intellectual Property Department, One PPG Place, Pittsburgh, PA, 15272, US

(21) Appl. No.: 11/020,906

(22) Filed: Dec. 23, 2004

(51) Int. Cl. B32B 27/40

(52) U.S. Cl. 428/423.1

(57) ABSTRACT

An article of manufacture having a rigid substrate and a soft-feel coating is disclosed. The soft feel coating comprises an acid functional polyurethane dispersion and a crosslinker. The polyurethane dispersion comprises an active hydrogen-containing polyether, dimethylolpropionic acid, a polyisocyanate and a chain extender; at least 70 percent of the acid functionality is neutralized.

### FIELD OF THE INVENTION

The present invention is directed to rigid substrates that have been coated with a coating that imparts to the substrate a “soft feel”. More specifically, the coating comprises an acid functional polyurethane composition and a crosslinker, as further described herein.

### BACKGROUND INFORMATION

Rigid or hard substrates are often coated with compositions that impart to the substrate a “soft feel”, i.e. a leather-like feel or a velvet-like feel. Such soft feel coatings are particularly desirable for those substrates that are handled a lot, such as consumer electronic products. It can be difficult to achieve a coating that imparts such soft feel, while still offering the desired level of mechanical and chemical resistance.

### SUMMARY OF THE INVENTION

The present invention is directed to an article of manufacture comprising a rigid substrate, and a soft feel coating on at least a portion of the substrate. The coating comprises an acid functional polyurethane dispersion comprising an active-hydrogen containing polyether having a weight average molecular weight of greater than or equal to 2000; dimethylolpropionic acid; a polyisocyanate; and a chain extender. At least 70 percent of the acid functionality is neutralized. The acid functional polyurethane is reacted with a crosslinker and cured to form the soft-feel coating.

### DETAILED DESCRIPTION OF THE INVENTION

The present invention is directed to an article of manufacture comprising a rigid substrate and a soft-feel coating on at least a portion of the substrate, wherein the coating comprises the reaction product of an acid functional polyurethane dispersion and a crosslinker, wherein the acid functional polyurethane dispersion comprises an active-hydrogen containing polyether having a weight average molecular weight of greater than or equal to 2000, dimethylolpropionic acid, a polyisocyanate, and a chain extender, and wherein at least 70 percent of the acid functionality is neutralized. “Polyurethane” as used herein includes polyurethanes, polyureas, and mixtures thereof.

The term “article of manufacture” is used in its broadest sense, and can include virtually any article comprising a rigid substrate and the soft feel coating according to the present invention. For example, articles of manufacture include, but are not limited to, furniture; appliances; cameras; writing implements including but not limited to pens and pencils; computer components including but not limited to mouse, keyboard, and the like; consumer electronics including but not limited to phones, PDAs, iPODS, dictaphones, cassette players, compact discs, MP3 players, and the like; personal hygiene equipment; sunglasses; automobile components including but not limited to steering wheels, dashboards, gear shifts, and the like. A “rigid” substrate refers to any substrate that is noncompressible, such as various plastics or wood products. “Plastics” can include, for example, polycarbonate, acrylonitrile butadiene styrene polymer blends (“ABS”), polypropylene, magnesium, and/or mixtures thereof; “plastics” can be filled or unfilled. Lightweight metals, such as magnesium, are also rigid substrates within the present invention. “Wood products” can include, for example, any product comprising wood, such as solid wood, hard woods, or products having at least two ply, such as veneers, composites, plywood, medium density fiberboard, low density fiberboard, and the like. It will be appreciated that a rigid substrate can still exhibit some degree of flexibility, but will typically not be a substrate that can undergo significant mechanical stresses, such as bending or stretching and the like, without significant irreversible change.

The coating used according to the present invention is one that imparts a “soft feel” to the substrate. The term “soft feel” will be understood as giving a velvet-like or leather-like feel to an otherwise hard substrate.

The soft-feel coating used according to the present invention comprises the reaction product of an acid functional polyurethane dispersion and a crosslinker. The polyurethane dispersion comprises an active hydrogen-containing polyether having a weight average molecular weight of greater than or equal to 2000. Suitable polyethers include those having an active hydrogen-containing group that is reactive with isocyanate. Examples include but are not limited to hydroxyl groups and amine groups. Nonlimiting examples of suitable active hydrogen-containing materials comprise polyols, polyethers, polyesters, polycarbonates, polyamides, polyurethanes, polyureas, polyamines, polyolefins, siloxane polyols, and mixtures thereof. In certain embodiments, the active hydrogen-containing material does not include acid functional groups. For example, the active hydrogen-containing polyether can be polytetramethylene ether glycol; such as that commercially available from Invista, Inc. as TERETHANE 2000.

Other examples of polyether polyols include polyalkylene ether (poly(oxyalkylene)) polyols, including but not limited to those having the following structural formula: 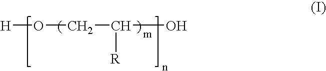
wherein the substituent R is hydrogen or lower alkyl containing from 1 to 5 carbon atoms including mixed substituents, m is an integer from 1 to 4, such as 1 or 2, and n is an integer ranging from 5 to 200; m, n and R are chosen such that the weight average molecular weight is 2000 or greater.

Also, polyethers obtained from the oxyalkylation of various polyols, for example, diols such as 1,6-hexanediol or higher polyols such as trimethylolpropane and sorbitol can be used. One commonly utilized oxyalkylation method is the reaction of a polyol with alkylene oxide, such as ethylene or propylene oxide, in the presence of an acidic or basic catalyst in a manner well known to those skilled in the art.

Examples of other suitable active hydrogen-containing polyethers are polymeric polyamines such as polyether polyamines for example, polyoxyalkylene polyamines. In the practice of the invention, where the expression “polyoxyalkylene polyamines” is used, what is intended are those polyamines containing both oxyalkylene groups and at least two amine groups, typically primary amine groups, per molecule.

An example of a particularly useful polyoxyalkylene polyamine is represented by the following structural formula: 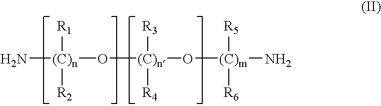
wherein m can range from 0 to 50, n can range from 1 to 50, n′ can range from 1 to 50, x can range from 1 to 50, y can range from 0 to 50 and R₁ through R₆ can be the same or different and can be independently selected from the group consisting of hydrogen or lower alkyl radicals preferably having 1 to 6 carbon atoms; again, the variables are chose so that the weight average molecular weight is 2000 or greater.

Another example of a useful polyoxyalkylene polyamine are those of the structure: 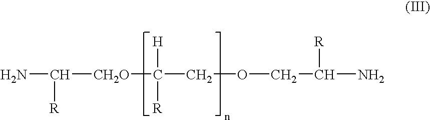
wherein R can be the same or different and is selected from hydrogen, lower alkyl radicals having from 1 to 6 carbon atoms, and n represents an integer ranging from 1 to 50, and may be 1 to 35; again, the variables are chosen so that the weight average molecular weight is 2000 or greater. Non-limiting examples include polyoxypropylene diamines such as JEFFAMINE D-2000, commercially available from Huntsman Corporation, Houston, Tex.

Mixed polyoxyalkylene polyamines can be used; that is, those in which the oxyalkylene group can be selected from more than one moiety. Examples include mixed polyoxyethylene-propylenepolyamines such as those having the following structural formula: 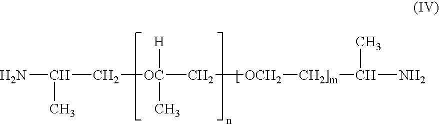
wherein m is an integer ranging from 1 to 49, and may be 1 to 34, and n is an integer ranging from 1 to 34 and where the sum of n+m is equal to 1 to 50, and may be 1 to 35; again, the variables are chosen so that the weight average molecular weight is 2000 or greater.

Besides the polyoxyalkylenepolyamines mentioned above, derivatives of polyoxyalkylenepolyols may also be used. Examples of suitable derivatives would be aminoalkylene derivatives that are prepared by reacting polyoxyalkylenepolyols such as those mentioned above with acrylonitrile, followed by hydrogenation of the reaction product in a manner well known to those skilled in the art. An example of a suitable derivative would be polytetramethylene glycol bis(3-aminopropyl(ether)). Other suitable derivatives would have the following structural formula: 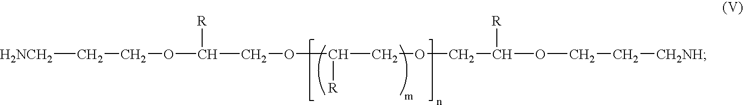
wherein the substituent R is hydrogen or lower alkyl containing from 1 to 5 carbon atoms including mixed substituents, m is an integer from 1 to 4, preferably 1 or 2, and n is an integer typically ranging from 5 to 200; again, the variables are chosen so that the weight average molecular weight is 2000 or greater.

For mixed oxyethylene-propylene groups in the polyether segment, the oxypropylene content can be at least 60 weight percent, such as at least 70 weight percent, or at least 80 weight percent based on total weight of the resin solids.

The polyether segment can be derived from a single type of polyether polyol or polyamine or various mixtures thereof.

Other suitable polyols include polycarbonate diols, polyester diols, hydroxyl-containing polydiene polymers, hydroxyl-containing di or trifunctional acrylic polymers, and mixtures thereof.

Examples of polyester polyols and hydroxyl-containing di or trifunctional acrylic polymers are described in U.S. Pat. Nos. 3,962,522 and 4,034,017, respectively, which are incorporated herein by reference. Examples of polycarbonate polyols are described in U.S. Pat. No. 4,692,383 in col. 1, line 58 to col. 4, line 14, which is incorporated herein by reference. Examples of hydroxyl-containing polydiene polymers are disclosed in U.S. Pat. No. 5,863,646, col. 2, lines 11-54, which is incorporated herein by reference. These polymeric polyols generally can have a weight average molecular weight ranging from 400 to 10,000 grams per mole.

Generally, the amount of active hydrogen-containing material that is used to prepare the polyurethane can be up to 70 weight percent, and may be in the range of 10 to 25 percent by weight based on total weight of the resin solids used to make the polyurethane component.

The polyurethane dispersion further comprises dimethylolpropionic acid. “Dimethylolpropionic acid” includes substituted dimethylolpropionic acid. According to the present invention, the dimethyl propionic acid is incorporated into the polymer without the use of pyrrolidones or other water-compatible, high boiling point solvents. Certain embodiments therefore specifically exclude such solvents, such as pyrrolidone and/or N-methylpyrrolidone.

The amount of dimethylolpropionic acid that is used to prepare the polyurethane is at least 1 percent, typically ranging from at least 1 to 20 percent, and in some embodiments ranging from 6 to 10 percent by weight based on total weight of the resin solids used to form the polyurethane.

The acid functional polyurethane further comprises a polyisocyanate. Suitable polyisocyanates used for preparing the polyurethane component can include aliphatic, cycloaliphatic, araliphatic, and aromatic isocyanates, and mixtures thereof.

Examples of suitable aliphatic and cycloaliphatic polyisocyanates include 4,4-methylenebisdicyclohexyl diisocyanate (hydrogenated MDI), hexamethylene diisocyanate (HDI), isophorone diisocyanate (IPDI), methylenebis(cyclohexyl isocyanate), trimethyl hexamethylene diisocyanate (TMDI), meta-tetramethylxylylene diisocyanate (TMXDI), and cyclohexylene diisocyanate (hydrogenated XDI). Other aliphatic polyisocyanates include isocyanurates of IPDI and HDI.

Examples of suitable aromatic polyisocyanates include tolylene diisocyanate (TDI) (i.e., 2,4-tolylene diisocyanate, 2,6-tolylene diisocyanate or a mixture thereof), diphenylmethane-4,4-diisocyanate (MDI), naphthalene-1,5-diisocyanate (NDI), 3,3-dimethyl-4,4-biphenylene diisocyanate (TODI), crude TDI (i.e., a mixture of TDI and an oligomer thereof, polymethylenepolyphenyl polyisocyanate, crude MDI (i.e., a mixture of MDI and an oligomer thereof), xylylene diisocyanate (XDI) and phenylene diisocyanate.

Polyisocyanate derivatives prepared from hexamethylene diisocyanate, 1-isocyanato-3,3,5-trimethyl-5-isocyanatomethylcyclohexane (“I PD I”), including isocyanurates thereof, and/or 4,4′-bis(isocyanatocyclohexyl)methane are also suitable.

The amount of polyisocyanate used to prepare the polyurethane component generally ranges from 15 to 50 percent by weight, and may range from 20 to 35 percent by weight based on total weight of the resin solids used to prepare the polyurethane component.

It will be appreciated that the acid functionality of the polyurethane dispersion derives from the dimethylolpropionic acid. According to the present invention, at least about 70 percent of the acid functionality on the polyurethane dispersion is neutralized. In certain embodiments, such as when a longer pot life is desired, the percent neutralization can be near 100 percent, such as at least 90 percent. In other embodiments, excess neutralizing agent can be added. Any appropriate neutralizing agent can be used. Examples include, but are not limited to, inorganic and organic bases such as sodium hydroxide, potassium hydroxide, ammonia, amines, alcohol amines having at least one primary, secondary, or tertiary amino group and at least one hydroxyl group. Suitable amines include alkanolamines such as monoethanolamine, diethanolamine, dimethylaminoethanol, diisopropanolamine, and the like. It will be further appreciated that the neutralizing agent forms a salt with the acid functionality on the polyurethane. The salt acts somewhat like a blocking agent in that it interferes with the reaction between the acid functionality and the crosslinker. This gives the uncured coating composition used in the present invention an excellent “pot life”. That is, the pot life of the uncured coating composition can range from 1 to 6 months. As noted above, there is a correlation between the amount of neutralization and the pot life. When the coating is deposited onto the substrate and/or heat is added, the neutralizing agent volatizes, leaving the acid functionality that is free to react with the crosslinker thus curing the coating.

The polyurethane further includes a chain extender, such as for example, a polyamine. Useful polyamines include primary or secondary diamines or polyamines in which the groups attached to the nitrogen atoms can be saturated or unsaturated, aliphatic, alicyclic, aromatic, aromatic-substituted-aliphatic, aliphatic-substituted-aromatic and heterocyclic. Exemplary suitable aliphatic and alicyclic diamines include 1,2-ethylene diamine, 1,2-propylene diamine, 1,8-octane diamine, isophorone diamine, propane-2,2-cyclohexyl amine, adipic acid dihydrazide, 2-amino ethyl ethanolamine, and the like. Suitable aromatic diamines include phenylene diamines and the toluene diamines, for example, o-phenylene diamine and p-tolylene diamine. These and other suitable polyamines are described in detail in U.S. Pat. No. 4,046,729 at column 6, line 61 to column 7, line 26, incorporated herein by reference. Based upon the total weight of resin solids from which the polyurethane component is formed, the amount of chain extender can range from 1 to 8 weight percent, and in some embodiments can range from 2.5 to 5 weight percent.

Any suitable crosslinker can be used. Particularly suitable are carbodiimide or aziridine crosslinkers. In certain embodiments, combinations of crosslinkers can be used. In other embodiments, only one crosslinker, such as carbodiimide or aziridine, is used.

The ratio of crosslinker to acid functionality can vary depending on the needs of the user. For example, the ratio can range from 0.1-1.5:1, such as 0.5:1.

In certain embodiments of the present invention, the coating is substantially solvent-free. “Substantially solvent-free” as used herein means that the coating composition contains less than about 15 or 20 weight percent organic solvents, such as less than 5 or 10 weight percent, with weight percent being based on the total weight of the coating composition. For example, the coating composition may contain from 0 to 2 or 3 weight percent organic solvents.

In certain embodiments of the present invention, the coating is “water-based”. The term “water-based” as used herein means coating compositions in which the carrier fluid of the composition is predominantly water on a weight percent basis, i.e. more than 50 weight percent of the carrier comprises water. The remainder of the carrier comprises less than 50 weight percent organic solvent, such as less than 25 weight percent or less than 15 weight percent. Based on the total weight of the coating composition (including the carrier in solids blend) the water may comprise from about 20 to about 80 weight percent, such as from about 30 to about 70 weight percent, of the total composition.

The polyurethane dispersion and crosslinker are generally present in the coating in an amount greater than 20 weight percent, such as greater than 40 weight percent and less than 90 weight percent, with weight percent being based on the total solid weight of the cured coating. For example, the weight percent of polyurethane dispersion and crosslinker can be between 20 and 80 weight percent.

The present coating compositions may optionally include other standard ingredients such as colorants, fillers, extenders, UV absorbers, light stabilizers, plasticizers, rheology modifiers, surfactants, thickeners and/or wetting agents, in a total amount of up to 80 weight percent based on the total weight percent of the coating composition. “Colorant” and like terms refer to any substance that imparts color and/or opacity and/or visual effect to the composition. The colorant can be added to the coating in any suitable form, such as discrete particles, dispersions, solutions and/or flakes. A single colorant or a mixture of two or more colorants can be used in the coating of the present invention.

Example colorants include pigments, dyes and tints, such as those used in the paint industry and/or listed in the Dry Color Manufacturers Association (DCMA) as well as special effect pigments and/or special effect compositions. A colorant may include, for example, a finely divided solid powder which is insoluble but wettable under the conditions of use. A colorant can be organic or inorganic and can be agglomerated or non-agglomerated.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those which are solvent and/or aqueous based, such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion, including but not limited to a nanoparticle dispersion. Nanoparticle dispersions can include one or more highly dispersed nanoparticle colorants or colorant particles that produce a desired visible color and/or opacity and/or visual effect. Nanoparticle dispersions can include colorants such as pigments or dyes having a particle size of less than about 150 nm, such as less than 70 nm, or less than 30 nm. Nanoparticles can be produced by milling stock organic pigments with grinding media having a particle size of less than 0.5 mm. Example nanoparticle dispersions and methods for making them are identified in U.S. Application Publication No. 2003/0125417, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,315 filed Jun. 24, 2004, which is incorporated herein by reference, and U.S. Provisional Application No. 60/482,167 filed Jun. 24, 2003, which is also incorporated herein by reference.

Example special effect pigments and/or special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect pigments and/or special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Patent Application Publication No. 2003/0125416, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention have minimal migration out of the coating. Example photosensitive compositions and photochromic compositions and methods for making them are identified in U.S. application Ser. No. 10/892,919 filed Jul. 16, 2004 and incorporated herein by reference.

In general, the colorant, if used, can be present in the coating composition in any amount sufficient to impart the desired visual and/or color effect while still maintaining the desired feel.

Any suitable method can be used to coat the substrates. For example, the coating can be sprayed, rolled, dipped, brushed, flow coated, curtain coated and the like. Following application to the substrate, the coating may undergo cure; for example, cure may be effected at room temperature for several days or at elevated temperatures such as 120° F. or higher, such as 180° F. or higher; dwell time in the oven will vary based on the temperature, airflow, and the like, and can be optimized by one skilled in the art. Typically, the dry film thickness of the cured coating will be from 0.5 to 4 mils, such as from 1 to 2 mils.

In one embodiment of the present invention, the polyurethane dispersion excludes the use of polyesters, including polyester polyols, and in another embodiment excludes neopentyl glycol. In another embodiment of the present invention, the neutralizing agent does not have only one hydroxy group and in another embodiment, the neutralizing agent does not have more than one hydroxy group. In another embodiment of the present invention, the polyether does not contain any aromatic moieties. In yet another embodiment of the invention, there is only one diol used to form the polyurethane. In yet another embodiment, cyclic carbonate groups are excluded, in another embodiment low molar mass polyols having a number average molecular weight of less than 500 g/mol are excluded, and in another embodiment polycaprolactone diols are excluded.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. For example, while the polyurethane dispersion has been described in terms of “a” polyether glycol, “an” acid functional material, “a” polyisocyanate and “a” chain extender, more than one of any these components can be used, as can more than one neutralizing agent, crosslinker, or any other component.

### EXAMPLES

The following examples are intended to illustrate the invention, and should not be construed as limiting the invention in any way.

### Example 1

A reaction vessel equipped with stirrer, thermocouple, condenser and nitrogen inlet was charged with 1010.3 grams (g) polytetramethylene ether glycol sold under the designation TERATHANE 2000 and 50.7 g dimethylolpropionic acid and heated to 60° C. 336.7 grams isophorone diisocyanate was added over 10 minutes followed by 356.2 g methyl ethyl ketone and 1.51 g dibutyltin dilaurate. The reaction exothermed to 63° C. The reaction temperature was raised to 80° C. and the contents were stirred until the isocyanate equivalent weight was 1380. Then 39.4 g dimethylolpropionic acid was added to the reaction flask. The contents were stirred until the isocyanate equivalent weight was 2094.

The resultant product had a solids content of 83.4 weight percent (measured for one hour at 110 C), an acid value of 21.20 mg KOH/g and a weight average molecular weight of 14971 in THF.

1552.0 grams of the above prepolymer at 76° C. was added over 25 minutes to a solution of 2259.9 g deionized water, 40.6 g adipic acid dihydrazide and 52.2 g dimethyl ethanol amine stirring at 21° C. and at 500 rpm in a cylindrical gallon reaction flask equipped with baffles, double pitched bladed stirrer, thermocouple and condenser. The dispersion temperature after this addition was 36° C. The reaction contents were stirred until no evidence of isocyanate was observed by FTIR.

This dispersion was transferred to a flask equipped with a stirrer, thermocouple, condenser and a receiver. The dispersion was heated to 60° C. and methyl ethyl ketone and water were removed by vacuum distillation.

The final dispersion had a solids content of 38.7 weight percent (measured from one hour at 11° C.), a Brookfield viscosity of 144 centipoises using a #2 spindle at 60 rpm, an acid content of 0.171 meq acid/g, a base content of 0.177 meq base/g, a pH of 8.26, a residual methyl ethyl ketone content of 0.15 weight percent and a weight average molecular weight of 95536 in DMF. This dispersion was then used to make coatings as follows:

TABLE 1

| | | Coating | Coating |
|---|---|---|---|
| | | Example 1: | Example 2: |
| Component | Description | (parts) | (parts) |
| Polyurethane | Prepared as | 58.83 | 69.73 |
| dispersion | described above | | |
| TEGO FOAMEX | Defoamer | 0.22 | 0.27 |
| 830^{A} | | | |
| NUOSPERSE | Wetting agent | 0.14 | 0.16 |
| FX365^{B} | | | |
| ACEMATT | Silicon dioxide | 1.40 | 1.66 |
| OK412^{C} | | | |
| TS100^{C} | Silicon dioxide | 2.29 | 2.70 |
| | flatting agent | | |
| DI Water | | 27.31 | 13.85 |
| CARBODILITE | Carbodiimide | 9.81 | 11.63 |
| VO2-L2^{D} | crosslinker | | |

| | | |
|---|---|---|
| Total | 100.00 | 100.00 |

^{A}Commercially available from Degussa-Goldschmidt Chemicals
^{B}Commercially available from Elementis Specialties
^{C}Commercially available from Degussa
^{D}Commercially available from Nisshinbo Chemicals

Incorporating the resin described in Resin Example 1, coatings were prepared in the following manner. The dispersion was agitated vigorously using a Cowles blade. Deformer and wetting agent were added, followed by the slow addition of the silicon dioxides. After addition of the silicon dioxide, the mixture was agitated for an additional 30 minutes. Water was then added for thinning to the solids/viscosity appropriate for application as described below. Prior to spray application, carbodiimide crosslinker was added and hand-stirred into the mixture. Coating #1 was spray applied to polycarbonate/ABS plaques. Coating #2 (higher solids offset) was applied to black (acrylic basecoat) medium density fiberboard (MDF).

TABLE 2

| | Polycarbonate/ABS | Medium Density |
|---|---|---|
| Test | Substrate | Fiberboard |
| VOC (theoretical | ˜0.3 | ˜0.3 |
| lbs/gal) | | |
| Cure | 20 min @ 180° F. | 20 min @ 180° F. |
| | 1 day at ambient | 1 day at ambient |
| DFT (mils) | 0.5 | 1.7-2.0 |
| Touch | “Satin” | “Rubbery” |
| Crosshatch | 100% | 100% |
| Adhesion¹ | | |
| Solvent | — | 60 MEK rubs |
| Resistance² | | |
| Humidity | — | — |
| Adhesion³ | | |
| Stain Testing⁴ | | |
| Orange Juice | — | No effect |
| Lemon Juice | — | No effect |
| Whiskey | — | Fail |
| Coffee | — | No effect |
| Isopropanol | — | No effect |
| Vinegar | — | No effect |
| Olive Oil | — | Fail |
| Red Wine | — | No effect |
| Ketchup | — | No effect |
| Mustard | Fail (Stain) | Fail |
| Lip Stick | Fail (Slight Stain) | — |
| Motor Oil | Fail (Gloss change) | — |
| Make-Up | Fail (Gloss change) | — |
| Hand Cream | Fail (Gloss change) | — |

¹ASTM D-3359; 100% = no loss of coating adhesion.
²ASTM D-5402-03 using either acetone or MEK as indicated.
³Samples were exposed for 10 days at 100° F., 100% relative humidity. They were than removed from the humidity chamber, wiped off, and evaluated for adhesion according to ASTM D-3359.
⁴Stain Testing: All staining agents were applied for approximately 24 hours, removed and any change in surface condition noted.

Whereas particular embodiments of this invention have been described above for purposes of illustration, it will be evident to those skilled in the art that numerous variations of the details of the present invention may be made without departing from the invention as defined in the appended claims.

What is claimed is:

1. An article of manufacture comprising:
(A) a rigid substrate;
(B) a soft feel coating on at least a portion of the substrate wherein the coating comprises the reaction product of
(i) an acid functional polyurethane dispersion and
(ii) a crosslinking agent; wherein the acid functional polyurethane dispersion comprises
(a) an active hydrogen-containing polyether having a molecular weight of greater than or equal to 2000;
(b) dimethylolpropionic acid;
(c) a polyisocyanate; and
(d) a chain extender;
wherein at least 70 percent of the acid functionality is neutralized.

2. The article of manufacture of claim 1, wherein the substrate comprises plastic.

3. The article of manufacture of claim 1, wherein the substrate comprises a wood product.

4. The article of manufacture of claim 3, wherein the substrate comprises medium density fiberboard.

5. The article of manufacture of claim 1, wherein the polyether comprises polyether glycol.

6. The article of manufacture of claim 5, wherein the polyether glycol comprises polytetramethylene ether glycol.

7. The article of manufacture of claim 1, wherein the acid functionality is neutralized with dimethylethanolamine.

8. The article of manufacture of claim 1, wherein the polyisocyanate comprises isophorone diisocyanate.

9. The article of manufacture of claim 1, wherein the chain extender comprises dihydrazine.

10. The article of manufacture of claim 1, wherein the crosslinker comprises carbodiimide.

11. The article of manufacture of claim 1, wherein
(a) the polyether comprises polytetramethylene ether glycol;
(b) the polyisocyanate comprises isophorone diisocyanate;
(c) the chain extender comprises dihydrazine; and
(d) the crosslinker comprises carbodiimide.

12. The article of manufacture of claim 1, wherein the coating is substantially solvent free.

13. The article of manufacture of claim 1, wherein the coating is water-based.

14. The article of manufacture of claim 1, wherein the 90 percent or greater of the acid functionality is neutralized.
